(19) United States
(12) Patent Application Publication
(10) Pub. No.: US 2009/0290846 A1
(43) Pub. Date: Nov. 26, 2009

(54) METHOD AND APPARATUS FOR RECORDING IMAGE IN ELECTRONIC APPARATUS

(75) Inventor: Chi-Hun WON, Seoul (KR)

Correspondence Address: Jefferson IP Law, LLP, 1130 Connecticut Ave., NW, Suite 420, Washington, DC, 20036, US

(73) Assignee: SAMSUNG ELECTRONICS CO. LTD., Suwon-si (KR)

(21) Appl. No.: 12/437,098

(22) Filed: May 7, 2009

(30) Foreign Application Priority Data
May 21, 2008 (KR) 10-2008-0046939

(51) Int. Cl. H04N 5/91; G06K 9/00; H04N 9/79

(52) U.S. Cl. 386/31; 386/68; 382/107; 386/E05.003; 386/E09.001

(57) ABSTRACT

A method and an apparatus for recording an image in an electronic apparatus are provided. The method includes extracting an image frame recorded last when a recording is temporarily suspended, when the recording restarts, determining whether an image frame input from a sensor, and the extracted image frame correspond with each other, and when the two image frames correspond with each other, automatically restarting the recording.

### PRIORITY

This application claims the benefit under 35 U.S.C. §119(a) of a Korean patent application filed in the Korean Intellectual Property Office on May 21, 2008 and assigned Serial No. 10-2008-0046939, the entire disclosure of which is hereby incorporated by reference.

### BACKGROUND OF THE INVENTION

1. Field of the Invention

The present invention relates to a method and an apparatus for recording an image in an electronic apparatus. More particularly, the present invention relates to a method and an apparatus for performing a smooth transition recording operation when a recording operation is temporarily suspended and resumes.

2. Description of the Related Art

As multimedia technology rapidly progresses, the number of electronic apparatuses having a function for shooting and storing a high-pixel still image or moving image has increased. For example, some portable terminals currently include a camcorder function for providing a moving image recording.

The camcorder function records a moving image desired for a certain time, and converts the moving image into a reproducible moving image file. Generally, the camcorder function provides a pause function and a resume function which allow a user to temporarily suspend a recording operation while the recording operation is being performed and then restart the recording operation.

Conventionally, any additional function between the pause function and the resume function is not provided in the camcorder function. That is, when a user pauses a recording function and then resumes the recording function, the recording of a moving image input via a sensor is temporarily suspended and then the recording of the moving image restarts when a restart event occurs. This function may be problematic when an image needs to be recorded continuously without being suspended.

For example, if a moving vehicle is suppose to be continuously recorded for ten minutes and a situation occurs when a recording operation is suspended due to an environmental factor or due to a user's circumstance in which the moving vehicle is recorded for about five minutes. The user temporarily suspends the recording operation and then restarts the recording after the situation causing the recording operation to be suspended is resolved. Frequently, a last image recorded when the recording has been temporarily suspended does not smoothly transition to a first image recorded when the recording restarts. Accordingly, a user may have to record the moving vehicle again from the beginning.

Therefore, a need exists for a method and apparatus for smoothly transitioning recording images when a recording operation is suspended temporarily and then restarted in an electronic apparatus.

### SUMMARY OF THE INVENTION

An aspect of the present invention is to address at least the above-mentioned problems and/or disadvantages and to provide at least the advantages described below. Accordingly, an aspect of the present invention is to provide a method and an apparatus for recording an image in an electronic apparatus.

Another aspect of the present invention is to provide a method and an apparatus for performing a smooth transition when an electronic apparatus temporarily suspends the recording and restarts the recording.

Still another aspect of the present invention is to provide a method and an apparatus for removing a frame difference between images generated due to a temporary suspension of a recording using a motion vector in an electronic apparatus.

Yet another aspect of the present invention is to provide an apparatus and a method for removing a frame difference between images generated due to temporary recording suspension using a last frame recorded when a recording function is temporarily suspended in an electronic apparatus.

In accordance with an aspect of the present invention, a method for recording an image in an electronic apparatus is provided. The method includes extracting an image frame recorded last when a recording is temporarily suspended, when the recording restarts, determining whether an image frame input from a sensor and the extracted image frame correspond with each other, and when the two image frames correspond with each other, automatically restarting the recording.

In accordance with another aspect of the present invention, a method for recording an image in an electronic apparatus is provided. The method includes extracting an image frame recorded last when a recording is temporarily suspended, applying alpha blending to the extracted image frame, displaying an image frame input from a sensor and the alpha blended image frame, and when a recording restart is requested, restarting the recording.

In accordance with still another aspect of the present invention, an apparatus for recording an image in an electronic apparatus is provided. The apparatus includes a camera sensor for receiving an image, and a controller for extracting an image frame recorded last when a recording is temporarily suspended, and when the recording restarts, for determining whether to restart the recording when an image frame input from the camera sensor and the extracted image frame correspond with each other.

In accordance with yet another aspect of the present invention, an apparatus for recording an image in an electronic apparatus is provided. The apparatus includes a camera sensor for receiving an image, a controller for extracting an image frame recorded last when a recording is temporarily suspended, and for applying alpha blending to the extracted image frame, and a display unit for displaying an image frame input from the camera sensor and the alpha blended image frame.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIGS. 1A to 1F are views illustrating an example of restarting recording in an electronic apparatus using a motion vector according to an exemplary embodiment of the present invention;

FIGS. 2A to 2F are views illustrating an example of restarting a recording in an electronic apparatus using a last image frame recorded according to an exemplary embodiment of the present invention;

FIG. 3 is a block diagram of an electronic apparatus according to an exemplary embodiment of the present invention; and

FIGS. 4A and 4B are flowcharts illustrating an operation procedure of temporarily suspending recording and restarting the recording in an electronic apparatus according to an exemplary embodiment of the present invention.

Throughout the drawings, it should be noted that like reference numbers are used to depict the same or similar elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, description of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces

Exemplary embodiments of the present invention provide a method and an apparatus for removing a frame difference between images generated when an electronic apparatus supporting a camcorder function temporarily suspends recording and restarts the recording using a motion vector or a last recorded image frame.

An exemplary embodiment of the present invention is described with the assumption that a problem is generated in an environment or in a vehicle at a point where the vehicle motion has been recorded for approximately fifteen seconds using the electronic apparatus and the recording is temporarily suspended. After the problem is resolved, the recording restarts.

The exemplary embodiments of the present invention provide a technique for removing a frame difference between images generated due to a temporary suspension in recording and when the recording restarts using a motion vector in the electronic apparatus.

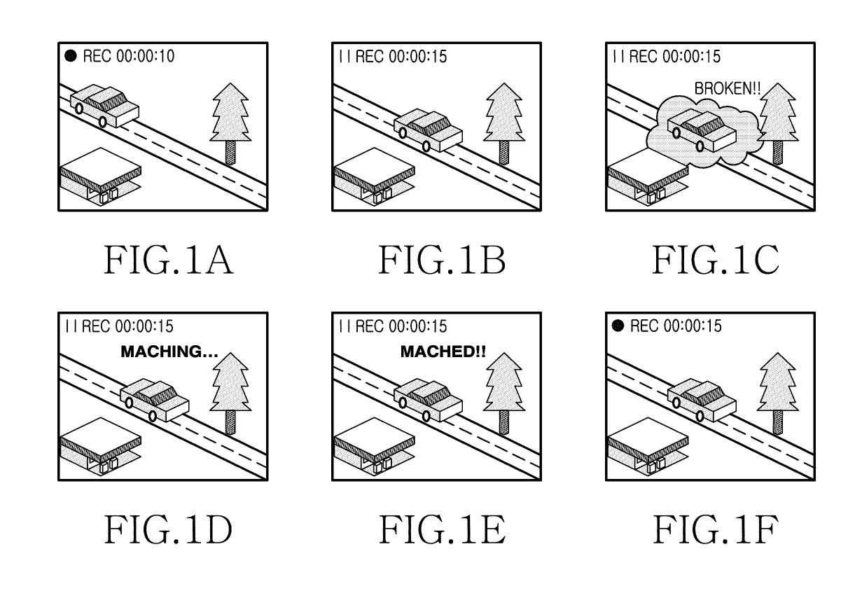

FIGS. 1A to 1F are views illustrating an example of restarting a recording in an electronic apparatus using a motion vector according to an exemplary embodiment of the present invention.

Referring to FIGS. 1A to 1F, the electronic apparatus extracts and stores an image frame recorded last of a moving vehicle using a camcorder function as illustrated in FIG. 1A. Recording is temporarily suspended at a point where approximately fifteen seconds have elapsed since the recording started as illustrated in FIG. 1B, due to an environment problem or a moving vehicle problem.

When the environment problem or the moving vehicle problem is resolved and recording restarts as illustrated in FIG. 1C, the electronic apparatus determines a motion vector between the above-extracted and stored last image frame and a current image frame input from a sensor. The electronic apparatus then compares the determined motion vector with a threshold. Here, the motion vector represents a similarity between the two image frames. When a value of the motion vector is small, the two image frames are considered to be similar to each other. At this point, the electronic apparatus may control a position, an angle and direction of the electronic apparatus, or control the position, the angle and the direction of the sensor as illustrated in FIG. 1D, with reference to the motion vector between the two image frames so that the next image frame input from the sensor and the last image frame become similar to each other.

The electronic apparatus continues comparing the motion vector between the two image frames with the threshold, determines whether the two image frames correspond with each other as illustrated in FIG. 1E, when the motion vector is smaller than the threshold, and automatically restarts the recording as illustrated in FIG. 1F.

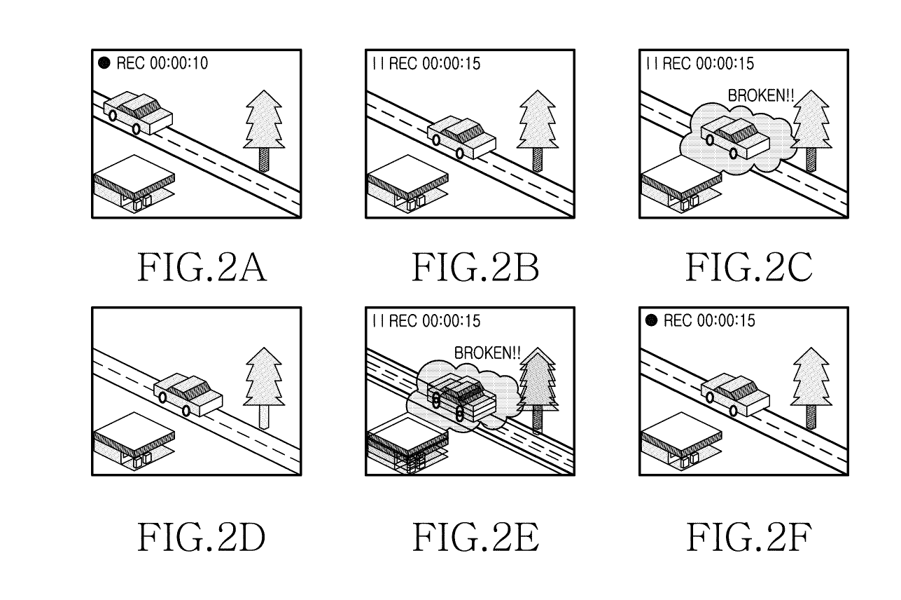

FIGS. 2A to 2F are views illustrating an example of restarting a recording in an electronic apparatus using a last image frame recorded according to an exemplary embodiment of the present invention.

Referring to FIGS. 2A to 2F, the electronic apparatus extracts and stores an image frame recorded last of a moving vehicle using a camcorder function as illustrated in FIG. 2A. Recording is temporarily suspended by a user at a point where approximately fifteen seconds have elapsed since the recording started as illustrated in FIG. 2B, due to an environment problem or a moving vehicle problem.

When the environment problem or the moving vehicle problem is resolved and recording restarts as illustrated in FIG. 2C, the electronic apparatus applies alpha blending to the extracted and stored last image frame as illustrated in FIG. 2D. The electronic apparatus transparently displays the alpha blended last frame on an On-Screen-Display (OSD) channel and displays an image frame input from the sensor at a current point as illustrated in FIG. 2E. That is, the last recorded image frame and the image frame currently input from the sensor are simultaneously viewed on the electronic apparatus by displaying the image frame currently input from the sensor on the OSD channel, and overlaying the alpha blended last image frame onto the OSD channel. Accordingly, the user may match the last image frame with the currently input image frame by directly controlling the position, the angle and the direction of the electronic apparatus or the sensor.

The user requests to restart recording by matching the image frames and the electronic apparatus restarts the recording according to the request of the user as illustrated in FIG. 2F.

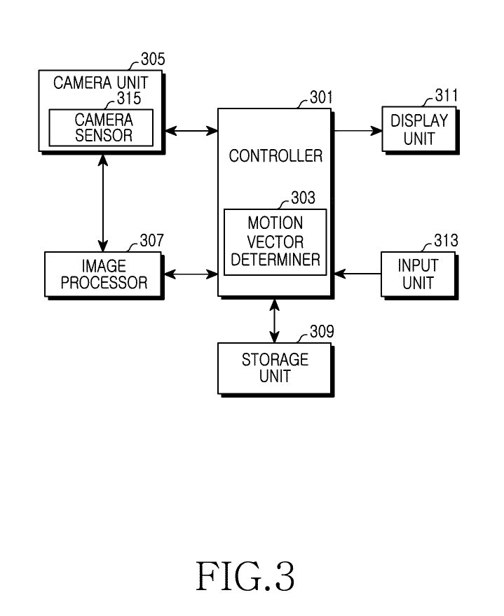

FIG. 3 is a block diagram of an electronic apparatus according to an exemplary embodiment of the present invention.

Referring to FIG. 3, the electronic apparatus includes a controller 301, a camera unit 305, an image processor 307, a storage unit 309, a display unit 311 and an input unit 313. The controller 301 includes a motion vector determiner 303. The camera unit 305 includes a camera sensor 315.

The controller 301 processes and controls overall operations of the electronic apparatus, for example, a recording function using a camcorder. The controller 301 processes and controls functions for removing a frame difference generated between a last recorded image frame and a restarting image frame when recording is temporarily suspended and recording restarts according to an exemplary embodiment of the present invention.

The controller 301 includes the motion vector determiner 303 that determines a motion vector between the last recorded image frame and a current image frame input from the camera sensor 315. The controller 301 compares the determined motion vector with a threshold, and determines whether the two image frames correspond with each other. The threshold may have a different value, and may be changed by the user.

The motion vector determiner 303 continues comparing a motion vector between the two image frames with the threshold, and determines whether the two image frames correspond with each other when the motion vector is smaller than the threshold. That is, the motion vector determiner 303 obtains a sum of X-axis motion vectors and a sum of Y-axis motion vectors between the two image frames, and continues comparing the motion vectors until the sum of the motion vectors reaches the threshold. Here, when the sum of the motion vector becomes (0,0), the two image frames perfectly correspond with each other. However, in an exemplary implementation, the sum of the motion vectors does not actually become (0,0). Therefore, the threshold is set to a value approaching (0,0). Also, the controller 301 guides an image frame input from the camera sensor 315 and the last image frame such that the two image frames are similar to each other by controlling the position, the angle, and the direction of the electronic apparatus or the camera sensor 315 until the motion vector determiner 303 determines that the two image frames correspond with each other.

That is, when the recording is temporarily suspended according to the user's request, the controller 301 extracts a last recorded image frame and separately stores the last image frame in the storage unit 309. When the recording restarts, as requested by the user, the controller 301 provides the last image frame to the motion vector determiner 303, receives a current image frame input via the camera sensor 315 from the image processor 307, and provides the current image frame to the motion vector determiner 303. When it is determined that the two image frames correspond with each other by the motion vector determiner 303, the controller 301 restarts recording.

Also, the controller 301 applies alpha blending to the extracted last image frame according to an exemplary embodiment of the present invention, and controls and processes functions for overlaying the alpha blended last image frame onto the OSD channel of the display unit 311. Here, the controller 301 converts the last image frame of a YUV format into a frame of an RGB565 format, and converts the frame of the RGB565 format into a frame of an ARGB4444 format by applying the alpha blending.

The camera unit 305 includes the camera sensor 315 for converting a light signal detected during image capturing into an electrical signal. The camera unit 305 also includes a signal processor (not illustrated) for converting an analog image signal shot by the camera sensor into digital data. The camera unit 305 outputs the image signal converted into the digital data to the image processor 307. Here, the camera sensor may be a Charge Coupled Device (CCD), and the signal processor may be a Digital Signal Processor (DSP).

The image processor 307 may be an image Coder-Decoder (CODEC). The image processor 307 encodes an image signal according to a set scheme, or decodes encoded frame image data into original frame image data.

The storage unit 309 includes a Read Only Memory (ROM), a Random Access Memory (RAM) and a flash ROM. The storage unit 309 stores micro-codes of a program for process operations and control operations of the controller 301, stores various reference data and stores temporary data generated while various programs are executed and various data updated for storage. More particularly, the storage unit 309 stores encoded image frame data and separately stores a last recorded image frame when recording is temporarily suspended, under control of the controller 301.

The display unit 311 displays status information, numbers and letters generated during an operation of the electronic apparatus. More particularly, the display 311 allows the last recorded image frame and the image frame currently input from the camera sensor 315 to be simultaneously viewed in the electronic apparatus by displaying the image frame currently input from the sensor on the OSD channel, and overlaying the alpha blended last image frame onto the OSD channel.

The input unit 313 includes a plurality of function keys and provides data corresponding to a key pressed to the controller 301. More particularly, the input unit 313 receives a temporary recording suspension and a restart request, and provides the request to the controller 301.

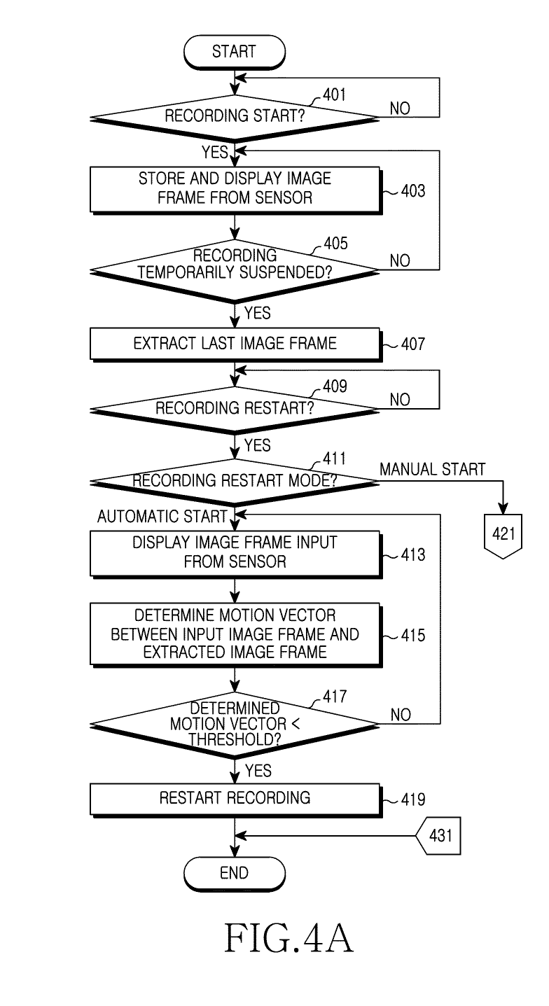

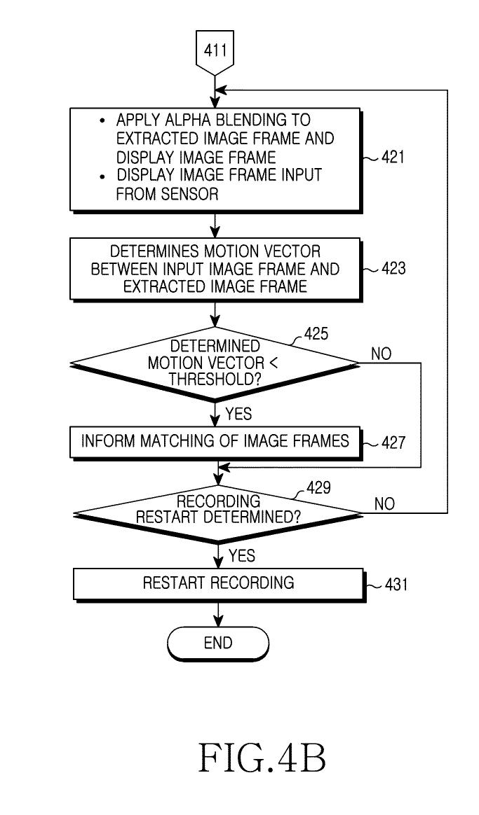

FIGS. 4A and 4B are flowcharts illustrating an operation procedure for temporarily suspending recording and restarting the recording in an electronic apparatus according to an exemplary embodiment of the present invention.

Referring to FIGS. 4A and 4B, when recording starts in step 401, the electronic apparatus stores the image frame in the storage unit 309 while displaying the image frame input from the camera sensor 315 on the display unit 311 in step 403.

In step 405, the electronic apparatus determines whether a recording is temporarily suspended. When the recording is not temporarily suspended, the electronic apparatus returns to step 403, and continues to perform an operation of storing and displaying an image frame input from the camera sensor 315.

When the recording is temporarily suspended, in step 407, the electronic apparatus stops storing an image frame input from the camera sensor 315 and extracts the last stored image frame from the stored image frames.

When the recording restarts in step 409, the electronic apparatus determines a recording restart mode in step 411. Here, the recording restart mode may be divided into an automatic start mode where the electronic apparatus directly determines whether the two image frames correspond with each other and automatically restarts the recording, and a manual start mode where the user determines whether the two image frames correspond with each other and receives a recording restart. The automatic start mode and the manual start mode may be set and changed by the user.

When the recording restart mode is set to the automatic start mode, the electronic apparatus displays an image frame input from the camera sensor 315 on the display unit 311 in step 413, and determines a motion vector between a currently input image frame and the extracted last image frame in step 415.

In step 417, the electronic apparatus compares the determined motion vector with a threshold. When the determined motion vector is equal to or greater than the threshold, the electronic apparatus determines that the two image frames do not correspond with each other, and returns to step 413 and performs the subsequent steps again. At this point, the electronic apparatus may control the position, the angle and the direction of the electronic apparatus, or control the camera sensor 315 so that the next image frame input from the camera sensor and the last image frame become similar to each other. Alternatively, the user may control the position, the angle and the direction of the electronic apparatus, or control the camera sensor.

On the other hand, when the determined motion vector is smaller than the threshold, the electronic apparatus determines that the two image frames correspond with each other. In step 419, the electronic apparatus then automatically restarts the recording. At this point, the electronic apparatus may inform the user that the two image frames correspond with each other and the recording then restarts. The electronic apparatus ends the recording procedure.

When the recording restart mode is set to the manual start mode, the electronic apparatus applies alpha blending to the extracted last image frame, displays the last image frame on the OSD channel of the display unit 311, and displays an image frame input from the camera sensor 315 on the display unit 311 in step 421. That is, the electronic apparatus transparently displays the last image frame so that the last recorded image frame and the image frame currently input from the camera sensor 315 may be simultaneously viewed in the electronic apparatus.

In step 423, the electronic apparatus determines a motion vector between the image frame currently input from the camera sensor 315 and the extracted last image frame. In step 425, the electronic apparatus compares the determined motion vector with the threshold.

When the determined motion vector is equal to or greater than the threshold, the electronic apparatus performs step 429 described below. When the determined motion vector is smaller than the threshold, the electronic apparatus informs the user that the two image frames correspond with each other in step 427. The electronic apparatus determines whether a recording restart is requested in step 429. Since the electronic apparatus informs the user that the two image frames correspond with each other through the motion vector, the user may clearly recognize that the two image frames correspond with each other.

When the recording restart is not requested, the electronic apparatus returns to step 421 and performs the subsequent steps again. When the recording restart is requested, the electronic apparatus goes to step 431 to restart the recording. When it is determined that the two image frames correspond with each other through the motion vector, the recording may automatically restart without receiving the recording restart request from the user.

The electronic apparatus then ends the recording procedure. Exemplary embodiments of the present invention provide a natural shooting image without a suspension between images by removing a frame difference between the last frame recorded when recording is temporarily suspended and a first frame recorded when the recording restarts, using a motion vector or the last recorded frame.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for recording an image in an electronic apparatus, the method comprising:
extracting an image frame recorded last when a recording is temporarily suspended;
when the recording restarts, determining whether an image frame input from a sensor and the extracted image frame correspond with each other; and
when the two image frames correspond with each other, automatically restarting the recording.

2. The method of claim 1, wherein the determining of whether the image frame input from the sensor and the extracted image frame correspond with each other comprises:
determining a motion vector between the image frame input from the sensor and the extracted image frame; and
comparing the motion vector with a threshold.

3. The method of claim 2, wherein the motion vector comprises a sum of X-axis motion vectors and a sum of Y-axis motion vectors between the image frame input from the sensor and the extracted image frame.

4. The method of claim 2, wherein the determining of whether the two image frames correspond with each other comprises:
when the motion vector is smaller than the threshold, determining that the two image frames correspond with each other;
when the motion vector is equal to or greater than the threshold, determining that the two image frames do not correspond with each other; and
continuously determining the motion vector between the input image frame and the extracted image frame.

5. The method of claim 2, wherein the threshold is changeable.

6. A method for recording an image in an electronic apparatus, the method comprising:
extracting an image frame recorded last when a recording is temporarily suspended;
applying alpha blending to the extracted image frame;
displaying an image frame input from a sensor and the alpha blended image frame; and
when a recording restart is requested, restarting the recording.

7. The method of claim 6, wherein the applying of the alpha blending to the extracted image frame comprises:
converting the extracted image frame of a YUV format into an image frame of an RGB565 format; and
converting the image frame of the RGB565 format into an image frame of an ARGB4444 format by applying the alpha blending to the converted image frame of the RGB565 format.

8. The method of claim 6, wherein the alpha blended image frame is displayed on an On-Screen-Display (OSD) channel.

9. The method of claim 6, further comprising:
determining a motion vector between the image frame input from the sensor and the extracted image frame;
comparing the determined motion vector with a threshold; and
when the motion vector is smaller than the threshold, informing that the two image frames correspond with each other.

10. The method of claim 9, wherein the threshold is changeable.

11. An apparatus for recording an image in an electronic apparatus, the apparatus comprising:
a camera sensor for receiving an image; and
a controller for extracting an image frame recorded last when a recording is temporarily suspended, and when the recording restarts, for determining whether to restart the recording when an image frame input from the camera sensor and the extracted image frame correspond with each other.

12. The apparatus of claim 11, wherein the controller determines a motion vector between the image frame input from the camera sensor and the extracted image frame, and determines whether the two image frames correspond with each other by comparing the determined motion vector with a threshold.

13. The apparatus of claim 12, wherein the motion vector comprises a sum of X-axis motion vectors and a sum of Y-axis motion vectors between the image frame input from the camera sensor and the extracted image frame.

14. The apparatus of claim 12, wherein the controller determines that the two image frames correspond with each other, when the motion vector is smaller than the threshold, and determines that the two image frames do not correspond with each other, when the motion vector is equal to or greater than the threshold, and continues to determine the motion vector between the input image frame and the extracted image frame.

15. The apparatus of claim 12, wherein the threshold is changeable.

16. An apparatus for recording an image in an electronic apparatus, the apparatus comprising:
a camera sensor for receiving an image;
a controller for extracting an image frame recorded last when a recording is temporarily suspended, and for applying alpha blending to the extracted image frame; and
a display unit for displaying an image frame input from the camera sensor and the alpha blended image frame.

17. The apparatus of claim 16, wherein the controller converts the extracted image frame of a YUV format into an image frame of an RGB565 format, and converts the image frame of the RGB565 format into an image frame of an ARGB4444 format by applying the alpha blending.

18. The apparatus of claim 16, wherein the display unit displays the alpha blended image frame on an On-Screen-Display (OSD) channel.

19. The apparatus of claim 16, wherein the controller controls functions for determining a motion vector between the image frame input from the camera sensor and the extracted image frame, for comparing the determined motion vector with a threshold, and for informing that the two image frames correspond with each other, when the motion vector is smaller than the threshold.

20. The apparatus of claim 19, wherein the threshold is changeable.
